(19) United States
(12) Patent Application Publication
(10) Pub. No.: US 2010/0084595 A1
(43) Pub. Date: Apr. 8, 2010

(54) LINE VALVE

(76) Inventor: Choon Il Kim, Seoul (KR)

Correspondence Address: IPLA P.A., 3550 WILSHIRE BLVD., 17TH FLOOR, LOS ANGELES, CA, 90010, US

(21) Appl. No.: 12/297,602

(22) PCT Filed: Apr. 17, 2007
(86) PCT No.: PCT/KR2007/001858

§ 371 Date: Oct. 17, 2008

(30) Foreign Application Priority Data
Apr. 17, 2006 (KR) 20-2006-0010192
Sep. 18, 2006 (KR) 10-2006-0090094
Oct. 23, 2006 (KR) 20-2006-0028257
Apr. 17, 2007 (KR) PCT/KR2007/001858

(51) Int. Cl. F16K 5/04

(52) U.S. Cl. 251/304

(57) ABSTRACT

The present invention provides a line valve. The line valve of the present invention includes a connection pipe (100), which has at least two hose connectors (110) and (120), each of which has a flow passage (111), (121) therein. The line valve further includes a rotary valve (200), which is rotatably provided in the connection pipe, such that communication between the flow passages is selectively controlled depending on rotation of the rotary valve. The rotary valve (200) includes a cover plate (210), which is exposed outside the connection pipe, and a cylindrical rotating body (260), which is rotatably provided in the connection pipe. The cylindrical rotating body has a passage hole (270) therein. An O-ring (280) is provided on the outer surface of the cylindrical rotating body at a position perpendicular to the passage hole. The O-ring is fastened to the cylindrical rotating body by a fastening member (290).

### TECHNICAL FIELD

The present invention relates to a line valve, which is provided on a water supply line, which includes a connecting hose for supplying water to a greenhouse or field, thus manually controlling the supply of water as necessary.

### BACKGROUND ART

Generally, to supply water to crops which are being cultivated in large fields or greenhouses, main water supply pipes, which are hard pipes or soft hoses having relatively large diameters, are coupled to storage pumps. Thereafter, separate connecting hoses branch from the main water supply pipes at positions spaced apart from each other at regular intervals. Subsequently, water spraying means, such as sprinklers, are coupled to respective connecting hoses, thus supplying water to the cultivated crops.

Here, line valves are provided on the connecting hoses, which are coupled to the water spraying means and branch from the main water supply pipe, in order to selectively control the supply of water such that water can be appropriately supplied to the desired areas.

Typically, such a line valve includes a connection pipe, which has at least two hose connectors on the opposite ends thereof, and a rotary valve, which is installed in the connection pipe and opens or closes flow passages defined in the hose connectors.

FIG. 1 is a perspective view showing a representative example of a rotary valve of a conventional line valve. The conventional rotary valve 20 has a passage hole 21, which communicates with or is isolated from flow passages of hose connectors depending on the rotation of the rotary valve. An O-ring 24 is provided on the rotary valve 20 at a position perpendicular to the passage hole 21. The O-ring 24 seals the area surrounding the flow passage of one hose connector, thus ensuring reliable watertightness of the flow passage of the hose connector. The O-ring 24 is seated into a seating groove 23, which is formed in the circumferential outer surface 22 of the rotary valve 20.

That is, depending on the rotation of the rotary valve 20, the passage hole 21 communicates with or is isolated from the flow passages of the hose connectors, thus connecting or separating the flow passages of the house connectors, which are disposed on opposite sides of the valve, with or from each other. In the case where the flow passages of the hose connectors are isolated from each other by the rotary valve 20, which is oriented in a predetermined direction, the O-ring 24 seals the area surrounding the flow passage of the corresponding hose connector.

However, the conventional line valve is disadvantageous in that the O-ring 24 may be undesirably removed from the seating groove 23 of the rotary valve 20 upon repeated rotation of the rotary valve 20, which causes water leakage. Furthermore, in a valve assembly process, in other words, when the rotary valve 20 is inserted into a valve seating hole of the connection pipe after the O-ring 24 is seated in the seating groove 23, the O-ring is partially or entirely removed from the seating groove, or may be damaged. As such, because there is a possibility of defective assembly of the O-ring 24, the confidence of consumers is reduced.

Moreover, in the conventional art, the hose connectors, which are provided on the opposite ends of the connection pipe, have basic structures such that they can be connected only to soft hoses. That is, it is difficult to directly connect the hose connector to a main water supply pipe made of hard material. Furthermore, when connecting the hose connector to a connecting hose that branches from the main water supply pipe using a separate fastening band, because a lot of effort is required to prevent water leakage, there are disadvantages in that the valve connecting process is very inconvenient and complex, and the cost of materials is increased.

### DISCLOSURE OF INVENTION

### Technical Problem

Accordingly, the present invention has been made keeping in mind the above problems occurring in the prior art, and an object of the present invention is to provide a line valve, in which, when flow passages are closed by orienting a rotary valve in a predetermined direction, watertightness can be reliably ensured, and which has a structure such that the defective proportion of products can be minimized.

Another object of the present invention is to provide a line valve in which the opening or closing rotation of the rotary valve is reliably conducted, thus enhancing the convenience of the opening or closing operation, and which can ensure convenience of use and reliability of the product and ensure the intended lifetime thereof.

A further object of the present invention is to provide a line valve in which hose connectors provided on opposite ends of a connection pipe have improved structures, so that the valve can be easily connected to any hose regardless of the kind of hose, including a hard hose and a soft hose, and which is constructed such that the water-tightness of a connection with the hard hose can be ensured, thus increasing the convenience of use.

Yet another object of the present invention is to provide a line valve in which the rotary valve is assembled with the connection pipe through an upper and lower double coupling structure, so that the rotary valve is prevented from being undesirably removed from the connection pipe by high water pressure, thus increasing the lifetime thereof.

Still another object of the present invention is to provide a line valve, which is constructed such that the distance that a locking protrusion of the rotary valve or the connection pipe extends outwards is minimized, so that the process of assembling the rotary valve to the connection pipe is simplified, and stress is prevented from being concentrated at an area around the locking protrusion in the assembly process, thus preventing it from being broken by high water pressure after the assembly of the valve has been completed.

Still another object of the present invention is to provide a line valve which has a structure such that the rotary valve can be precisely rotated at an angle of 90° to turn on or off the valve, thus ensuring convenience of use.

Still another object of the present invention is to provide a line valve, which is constructed such that a removable type soft or hard hose connector is used as the hose connector provided on the connection pipe, so that the valve can be selectively used for its intended purpose, thus increasing convenience and the application range.

Still another object of the present invention is to provide a line valve, which is constructed such that a cylindrical rotating body and a handle part, which constitute the rotary valve, are separable from each other, so that the rotary valve can be formed such that the handle is sufficiently thick, thus preventing the handle from breaking in the winter or similar circumstances, thereby ensuring the intended lifetime thereof, and in which the removable type hose connector, which is used as the hose connector of the connection pipe, has a hook coupling structure such that the assembly thereof is convenient and it can be rapidly assembled, thus increasing the convenience of installation of the valve, and ensuring watertightness between the valve and the hose, thereby enhancing the value of the product.

### Technical Solution

In order to accomplish the above objects, the present invention provides a line valve, including: a connection pipe including at least two hose connectors oriented in directions different from each other, each of the hose connectors having a flow passage therein; and a rotary valve rotatably provided in the connection pipe, such that communication between the flow passages is selectively controlled depending on axial rotation of the rotary valve, wherein the rotary valve comprises a cover plate exposed outside the connection pipe, and a cylindrical rotating body rotatably provided in the connection pipe, and the cylindrical rotating body has a passage hole therein, and an O-ring is provided in a circumferential outer surface of the cylindrical rotating body at a position perpendicular to the passage hole, the O-ring being fastened to the cylindrical rotating body by a fastening member.

Preferably, a coupling recess may be formed in the circumferential outer surface of the cylindrical rotating body at the position perpendicular to the passage hole, a ring-shaped stepped part may be formed in an outer edge of the coupling recess, and a ring-shaped rounded part may be formed in an outer edge of the ring-shaped stepped part, wherein the fastening member has an outer diameter less than an inner diameter of the ring-shaped stepped part, and a rounded part is formed in an outer edge of the fastening member, and the O-ring is seated into the ring-shaped stepped part, the O-ring being partially surrounded both by the rounded part of the ring-shaped stepped part and by the rounded part of the fastening member, so that part of the O-ring is exposed outside the rounded parts.

Furthermore, the fastening member may have a curvature radius equal to a curvature radius of the cylindrical rotating body.

As well, one hose connector selected from the two or more hose connectors may include: a plurality of removal prevention protrusions formed on a circumferential outer surface of the hose connector, each of the removal prevention protrusions having a right-angled triangular cross-section, one surface of which is inclined in one direction, wherein the inclined surface of the removal prevention protrusion faces a direction in which a hose is connected to the hose connector.

In addition, one hose connector selected from the two or more hose connectors may include: an insert part provided on an end of the hose connector, the insert part being increased in diameter to a distal end thereof; and a ring-shaped packing fitted over a circumferential outer surface of the insert part so that the ring-shaped packing is brought into close contact with an area around a hole formed in a hard hose by an external force, the ring-shaped packing being radially extended outwards when the ring-shaped packing is compressed towards the insert part.

Moreover, the hose connector may further include: a tightening nut threaded onto the circumferential outer surface of the hose connector, so that the ring-shaped packing is compressed towards the insert part by the tightening nut.

Preferably, the cover plate of the rotary valve may be rotatably coupled to the connection pipe.

The cylindrical rotating body of the rotary valve may include a support shaft protruding from a lower end of the cylindrical rotating body, and the connection pipe may have in a bottom thereof a support shaft pipe rotatably supporting the support shaft.

Furthermore, an O-ring may be provided on a circumferential outer surface of the support shaft, and the support shaft may be rotatably coupled at a lower end thereof to a lower end of the support shaft pipe.

As well, at least one support protrusion may radially protrude inwards from a circumferential inner surface of the support shaft pipe.

The connection valve may include a valve seating part, to which the rotary valve is coupled, the valve seating part having therein a receiving space in which the rotary valve is rotatably received.

In addition, the valve seating part may have an open-and-close restraining guide recess in an upper end thereof, and the rotary valve may have a stop protrusion to be guided along the open-and-close restraining guide recess, so that an angle by which the rotary valve is rotated is limited within a predetermined range.

Furthermore, the cover plate and the cylindrical rotating body may be separably assembled with each other.

Preferably, an O-ring may be provided on a lower end of the cover plate to ensure watertightness between the cover plate and the cover plate.

Moreover, each of the two or more hose connectors may comprise a removable type hose connector separably coupled to the connection pipe.

The removable type hose connector may include: a pipe body removably and watertightly coupled at a first end thereof to the connection pipe; an insert part provided on a second end of the pipe body and having a tapered surface; and a tightening nut threaded onto a circumferential outer surface of the pipe body.

Furthermore, a compression packing may be interposed between the insert part and the tightening nut.

In addition, the tightening nut may have a tapered surface on a circumferential inner surface of an end thereof adjacent to the insert part corresponding to the tapered surface of the insert part.

Preferably, each of the tapered surfaces may be curved at a predetermined curvature radius.

As well, the pipe body may have at least one hook on the first end thereof, and the connection pipe may have at least one key notch corresponding to the hook.

### Advantageous Effects

In the line valve according to the present invention, the structure for mounting an O-ring to a rotary valve, constituting the line valve, is improved, so that the defective proportion in an assembly process is markedly reduced, and the intended lifetime thereof is ensured, thus increasing the reliability of products. Furthermore, a hose connector has an improved structure such that it can be easily coupled to a hard hose, thus enhancing the convenience of use and reducing the installation costs.

In addition, the rotary valve is assembled with the connection pipe through an upper and lower double coupling structure, so that the rotary valve is prevented from being undesirably removed from the connection pipe by high water pressure, thus ensuring the intended lifetime thereof, thereby increasing the reliability of the product. As well, the rotating motion of the rotary valve for turning on/off the valve can be precisely conducted, thus ensuring convenience of use. Furthermore, a removable type soft or hard hose connector is used as the hose connector provided on the connection pipe, so that the valve can be selectively used for the intended purpose thereof, thus increasing the convenience and compatibility of the product, that is, increasing the application range of the product.

Moreover, the rotary valve may be constructed such that it is dividable into several bodies. In this case, because the rotary valve can be formed such that the handle is sufficiently thick, the handle is prevented from being broken in the winter or similar circumstances, thus ensuring the intended lifetime the valve, and minimizing the defective proportion thanks to the superior assemblability. The hose connector may have a removable type structure, so that convenience of the installation of the valve is ensured, thus enhancing the value of the product.

### BRIEF DESCRIPTION OF THE DRAWINGS

FIG. 1 is a perspective view showing part of a conventional line valve to illustrate the coupling construction of an O-ring of the valve;

FIG. 2 is a sectional view of a line valve according to a first embodiment of the present invention, illustrating a closed state of a flow passage of the line valve;

FIG. 3 is a sectional view of the line valve according to the first embodiment of the present invention, illustrating an opened state of the flow passage of the line valve;

FIG. 4 is an enlarged sectional view of the portion “F” of FIG. 2;

FIG. 5 is an enlarged sectional view of the portion “G” of FIG. 4;

FIG. 6 is an enlarged sectional view of the portion “H” of FIG. H;

FIGS. 7 and 8 are perspective views illustrating the coupling construction of an O-ring according to the present invention, showing a fastening member at different angles;

FIGS. 9 and 10 are enlarged sectional views showing a process of coupling a hose connector to a hard hose according to the present invention, in which FIG. 9 is a view showing the hose connector inserted into a hole of the hard hose before it is tightened using a tightening nut, and FIG. 10 is a view the state in which a packing is compressed and varied in shape by the tightening nut and the hole of the hard hose is thus sealed by the packing;

FIG. 11 is a perspective view showing an assembled second embodiment of the present invention;

FIG. 12 is an exploded perspective view of FIG. 11;

FIG. 13 is an exploded perspective view showing a rotary valve according to the present invention;

FIG. 14 is a front view of the present invention;

FIG. 15 a sectional perspective view showing a connection pipe and the rotary valve, which are separated from each other, according to the present invention;

FIG. 16 is a longitudinal sectional view of the present invention, showing the closed state of the flow passage;

FIG. 17 is a cross-sectional view of FIG. 17;

FIG. 18 is an enlarged view showing part of FIG. 17;

FIG. 19 is a longitudinal sectional view of the present invention, showing the opened state of the flow passage;

FIG. 20 is a cross-sectional view of FIG. 19;

FIG. 21 is an enlarged view showing the portion “IV” of FIG. 19;

FIG. 22 is an enlarged view showing part of FIG. 20;

FIG. 23 is a longitudinal sectional view showing a modification of the second embodiment of the present invention;

FIGS. 24 and 25 respectively are an enlarged view and an exploded perspective view showing the portion “V” of FIG. 23;

FIG. 26 is an exploded perspective view showing the construction of another modification of the second embodiment of the present invention;

FIG. 27 is a longitudinal sectional view showing the assembled state of FIG. 26;

FIGS. 28 and 29 are views showing a process of coupling a hard hose connector of FIG. 26 to a hard hose;

FIG. 30 is an exploded perspective view showing the construction of a further modification of the second embodiment of the present invention;

FIG. 31 is a longitudinal sectional view showing the assembled state of FIG. 30;

FIGS. 32 and 33 are views showing a process of coupling a removable type hose connector of FIG. 30 to a hard hose;

FIG. 34 is a perspective view showing an assembled state of a third embodiment of the present invention;

FIG. 35 is an exploded perspective view of the third embodiment of the present invention;

FIG. 36 is an exploded sectional perspective view of the third embodiment of the present invention;

FIG. 37 is a longitudinal sectional view of the third embodiment of the present invention, showing a closed state of the valve;

FIG. 38 is a longitudinal sectional view of the third embodiment of the present invention, showing an opened state of the valve;

FIG. 39 is a sectional view of an assembled state of a removable type hose connector of the third embodiment of the present invention;

FIGS. 40 and 41 are views illustrating the usage of the removable type hose connector of FIG. 39;

FIG. 42 is a perspective view showing an assembled state of a modification of the third embodiment of the present invention;

FIG. 43 is a partially exploded perspective of FIG. 42;

FIG. 44 is a longitudinal sectional view of FIGS. 42; and

FIG. 45 is an enlarged view showing part of FIG. 44.

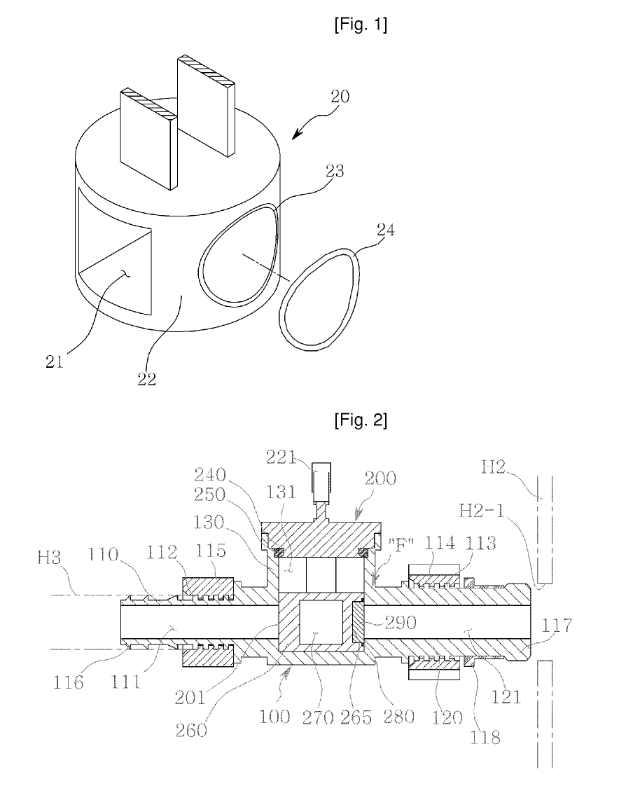

### BEST MODE FOR CARRYING OUT THE INVENTION

Hereinafter, the construction of the present invention will be described in detail with reference to the attached drawings.

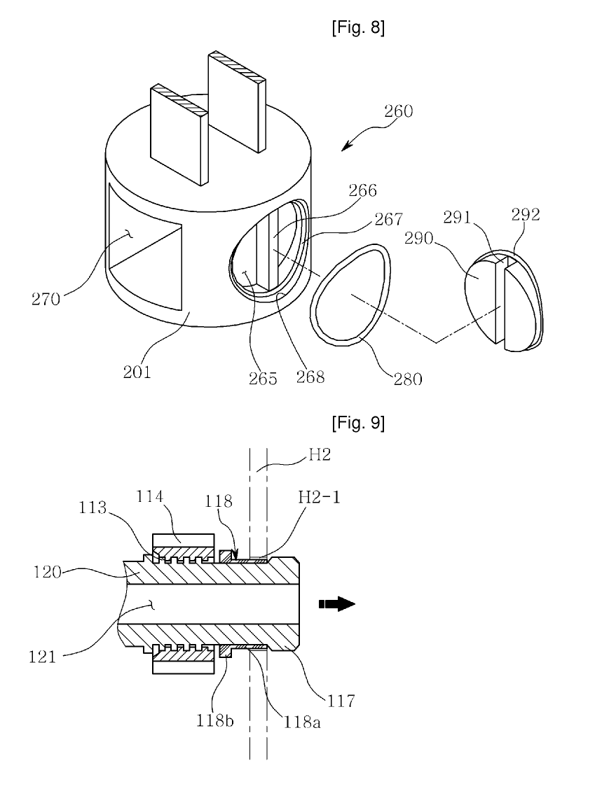

As shown in FIGS. 2 through 10, a first embodiment of the present invention includes a connection pipe 100 and a rotary valve 200, which is rotatably installed in the connection pipe 100.

The connection pipe 100 includes at least two hose connectors 110 and 120. External threaded parts 112 and 113 are formed on the circumferential outer surfaces of respective hose connectors 110 and 120. Tightening nuts 114 and 115 respectively engage with the threaded parts 112 and 113 so as to conduct screw movement. The hose connectors 110 and 120 have respective flow passages 111 and 121.

Furthermore, the connection pipe 100 has a valve seating part 130 in a medial portion thereof. The valve seating part 130 defines therein a receiving space 131, which communicates with the flow passages 111 and 121. The rotary valve 200 is rotatably received in the receiving space 131. A ring-shaped stepped depression 140 is formed in the circumferential inner surface of the upper end of the valve seating part 130. A ring-shaped locking step 150 is provided in the circumferential outer surface of the upper end of the valve seating part 130.

The rotary valve 200 has in the lower end thereof a cylindrical rotating body 260, which is rotatably received in the receiving space 131 of the valve seating part 130. The cylindrical rotating body 260 has a passage hole 270 therein. Depending on the rotation of the rotary valve 200, the flow passages 111 and 121 of the hose connectors 110 and 120 communicate with each other through the passage hole 270 or are isolated from each other. Furthermore, an O-ring 280, which seals one of the flow passages 111 and 121, is provided in the cylindrical part 201 at a position perpendicular to the passage hole 270.

The rotary valve 200 has a handle 221 and a cover plate 210 in the upper end thereof. The cover plate 210 includes a boss 220, which is rotatably inserted into the ring-shaped stepped depression 140 of the valve seating part 130. Hooks 230 are provided at predetermined positions on the outer edge of the cover plate 210. The hooks 230 are locked to the ring-shaped locking step 150, by which the cover plate 210 is rotatably supported in the connection pipe 100. Furthermore, an O-ring seat 240 is formed in the circumferential outer surface of the lower end of the boss 220, and an O-ring 250 is seated in the O-ring seat 240.

Meanwhile, a soft hose H3 is fitted over the circumferential outer surface of the first hose connector 110 of the connection pipe 100. Removal prevention protrusions 116 are formed on the circumferential outer surface of the first hose connector 110 to prevent the soft hose H3, which has been fitted over the first hose connector 110, from being undesirably removed therefrom. Each removal prevention protrusion 116 has a right-angled triangular cross-section, one surface of which is inclined in one direction. The removal prevention protrusion 116 is configured such that the inclined surface thereof faces the direction in which the soft hose H3 is fitted over the first hose connector.

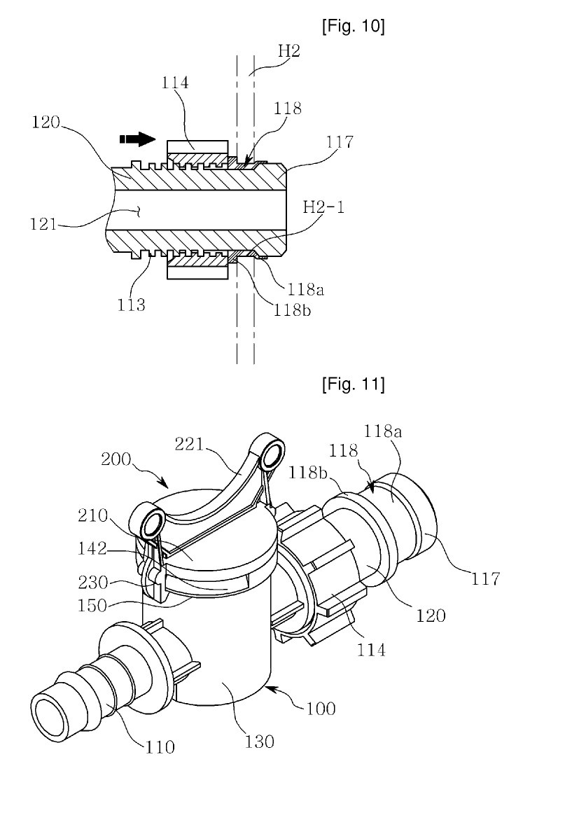

As shown in the enlarged views of FIGS. 9 and 10, the second hose connector 120 includes an insert part 117, which is fitted into a hole H2-1 of a hard hose H2. The insert part 117 has an outer diameter greater than that of the second hose connector 120. Furthermore, a packing 118 is provided between the insert part 117 and the tightening nut 115.

Preferably, the packing 118 may include a close contact ring part 118a, which has an outer diameter less than that of the insert part 117, and a flange part 118b to be compressed by the advancement of the tightening nut 115.

Meanwhile, as shown in FIGS. 4 through 8, a coupling recess 265 is formed in the circumferential outer surface 201 of the cylindrical rotating body 260 of the rotary valve 200 at a position perpendicular to the passage hole 270. A fastening member 290 is fitted into the coupling recess 265.

Furthermore, a position determination protrusion 266 is provided at the central position in the coupling recess 265. A ring-shaped stepped part 267 is formed in the edge of the coupling recess 265. A ring-shaped rounded part 268 is formed in the outer edge of the ring-shaped stepped part 267. The O-ring 280 is seated into a space defined by the ring-shaped stepped part 267 and the ring-shaped rounded part 268.

The fastening member 290 has therein a coupling slot 291, into which the position determination protrusion 266 is inserted. The outer surface of the fastening member 290 has the same curvature as the cylindrical part 201 of the rotary valve 200. In addition, the outer edge of the fastening member 290 has an outer diameter less than the inner diameter of the ring-shaped stepped part 267. A ring-shaped rounded part 292 is formed in the outer edge of the fastening member 290.

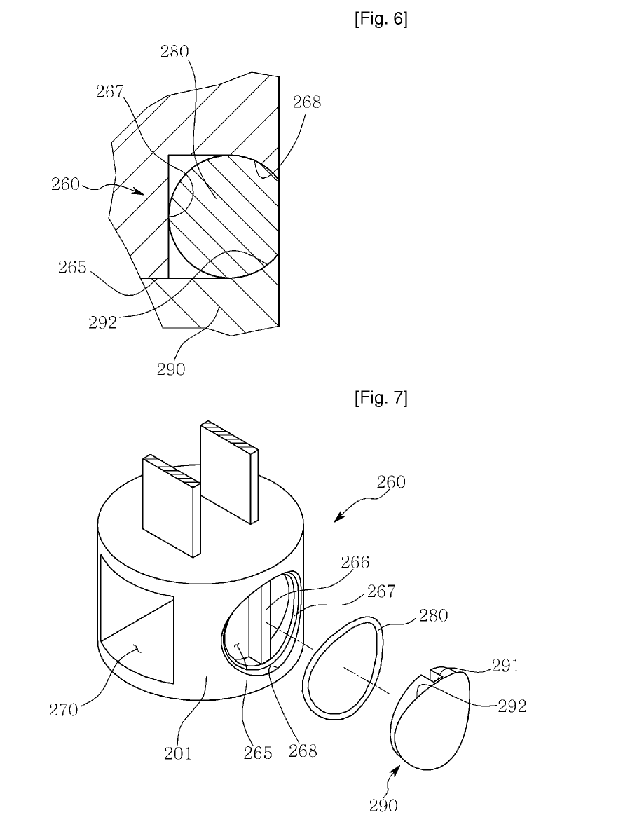

Thus, when the fastening member 290 is inserted into the coupling recess of the cylindrical rotating body 260, the O-ring 280 is partially surrounded both by the rounded part 268 of the stepped part 267 and by the rounded part 292 of the fastening member 290, as shown in FIGS. 5 and 6. Thereby, the O-ring 280 is reliably retained in the cylindrical rotating body 260 by the fastening member 290. As well, part of the O-ring 280 protrudes outwards from the cylindrical rotating body 260.

Here, the fastening member 290 is formed such that the outer surface thereof has the same curvature as he cylindrical part 201 of the cylindrical rotating body 260, so that smooth rotation of the rotary valve 200 is ensured.

When the rotary valve 200 is rotated and oriented in a predetermined direction, the protruding part of the O-ring 280, which contacts the circumferential inner surface of the receiving space 131 of the connection pipe 100, comes into close contact with the area surrounding the flow passage 111 or 121 of any one of the hose connectors 110 and 120, thereby sealing the flow passage 111 or 121.

As such, because the O-ring 280 is reliably assembled with the rotary valve 200, it is prevented from being removed from the rotary valve 200 when the rotary valve 200 is inserted into the receiving space 131 of the connection pipe 100, thus minimizing the defective proportion and malfunctions. Moreover, even after the rotary valve has been used for a long period (a rotating motion for opening or closing the valve is repeated many times), the O-ring 280 is prevented from being undesirably removed or damaged, thus ensuring superior watertightness and the intended lifetime of the valve.

In the embodiment of the present invention, although the valve has been illustrated as being provided with a single sealing structure including the O-ring 280, two sealing structures may be provided at respective opposite positions of the cylindrical rotating body, in detail, at respective opposite positions perpendicular to the passage hole 270, in order to further increase the watertightness of the valve.

Meanwhile, in the present invention, a soft hose connector for connection with a soft hose and a hard hose connector for connection with a hard hose are used as the respective hose connectors 110 and 120, which are provided on the opposite ends of the connection pipe 100, so that the hard hose connector can be directly and watertightly coupled to the hard hose H2, which is a main water supply pipe, thus making it convenient to install the valve.

In other words, in the present invention, the hard hose connector 120, which is disposed at one position on the connection pipe, is connected to the hard hose H2, which is the main supply pipe, and the soft hose H3 is connected to the soft hose connector 110, which is disposed at the other position, opposite the hose connector 120.

To connect the soft hose to the corresponding hose connector, as is well known in the art, the user inserts and pushes the front end of the hose connector 110 into the soft hose H3 at least until it is inserted adjacent to the tightening nut 115. Thereafter, the tightening nut 115 is moved (advanced towards the soft hose) on the hose connector 110 by the screw movement. Then, the soft hose H3 is tightly held between the removal prevention protrusions 116 and the tightening nut 115, thus reliably ensuring watertightness.

The process of connecting the hose connector 120 to the hard hose H2 is illustrated in FIGS. 9 and 10.

In detail, to construct a branch line from the hard hose H2, the present invention is connected to one of a predetermined number of holes H2-1, which are formed in the hard hose H2.

As shown in FIG. 9, the user inserts the insert part 117 of the hose connector 120 into the hard hose H2 through the hole H-1.

Here, because the hole H2-1 formed in the hard hose H2 has a diameter equal to or slightly greater than the diameter of the insert part 117, the insert part 117 can be easily inserted into the hole H2-1.

Furthermore, the close contact ring part 118a of the packing 118 is inserted into the hole H2-1. Of course, because the close contact ring part 118a has an outer diameter less than that of the insert part 117, it can be easily inserted into the hole H2-1.

In this state, as shown in FIG. 10, the user rotates the tightening nut 114 along the threads. Then, the tightening nut 114 is advanced forwards, so that the flange part 118b of the packing 118 is compressed. Thereby, the close contact ring part 118a is pushed to the circumferential outer surface of the insert part 117, and is simultaneously increased in diameter. When the tightening nut 114 is tightened further, the flange part 118b is brought into contact with the area around the hole H2-1. In addition, the close contact ring part 118a reaches a limit position, at which it can no longer be moved by pushing force, and then is contracted and increased in diameter, thus watertightly filling the hole H2-1, and preventing the insert part from escaping from the hole H2-1. As such, the connection process is simple.

Therefore, unlike the conventional arts, the present invention does not require a branch pipe, which is installed to extend from the main water supply pipe, that is, the hard hose, in a separate construction process, thus reducing the installation costs thereof, and being convenient for the user.

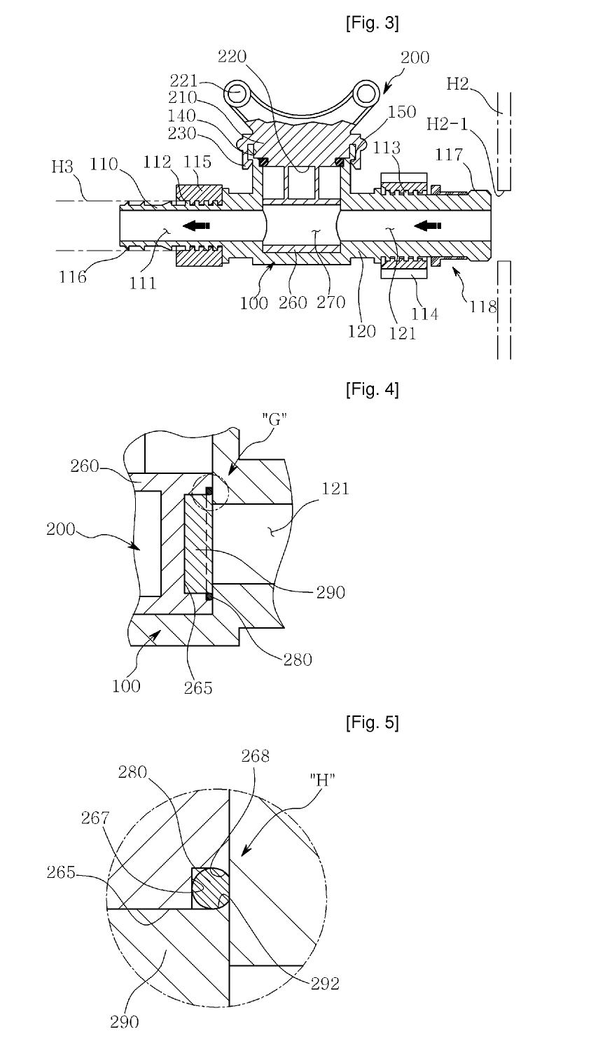

The line valve shown in FIGS. 2 and 3 provides a reliable assembly structure such that the O-ring 280, which is assembled with the rotary valve 200, is prevented from being undesirably removed therefrom. Therefore, when the rotary valve 200 is assembled with the connection pipe 100, because the O-ring 280 of the cylindrical rotating body 260 is prevented from being removed or damaged, the assembly process can be easily and rapidly conducted, and a defective proportion of the products is markedly reduced. Furthermore, because the O-ring 280 can maintain its position, at which it is assembled with the cylindrical rotating body 260, the intended lifetime thereof is ensured. In addition, the hose connector 120, which is provided in the one end of the connection pipe 100, is constructed such that it can be directly connected to the hard hose H2, which is the main water supply pipe, so that there is an advantage in that the utility thereof is increased.

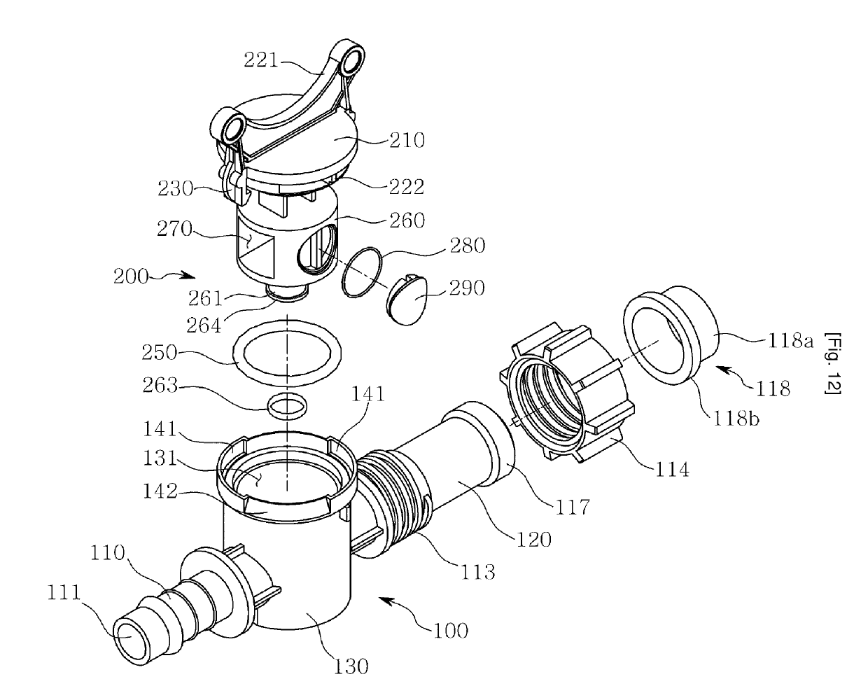

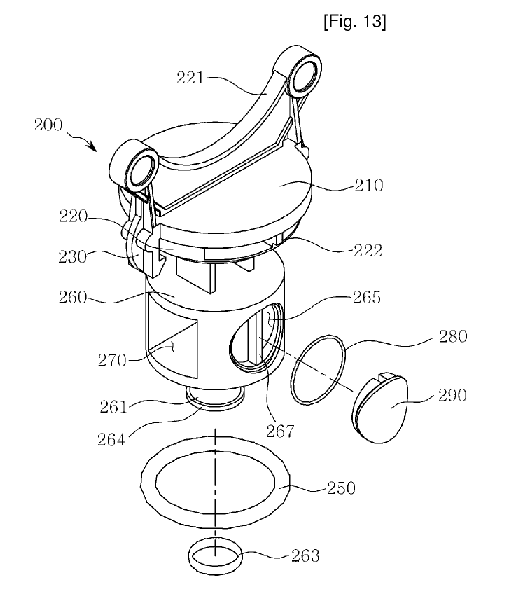

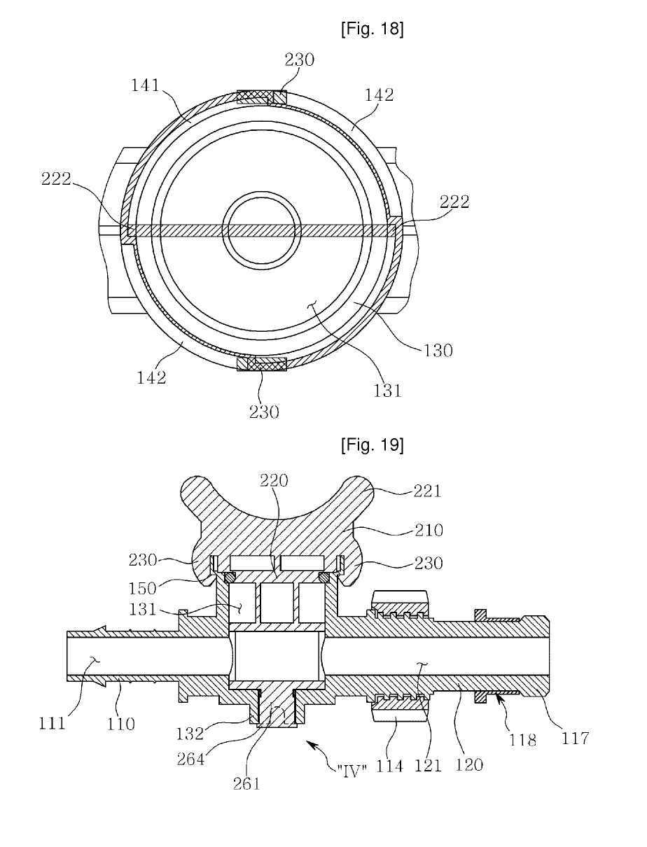

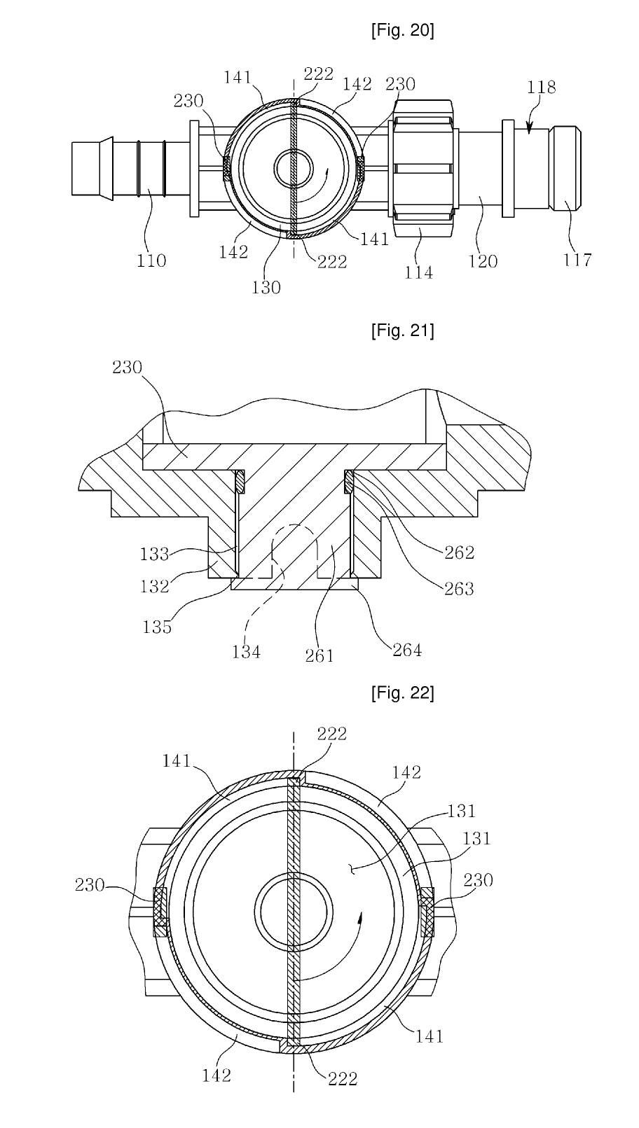

FIGS. 11 through 22 illustrate a line valve according to a second embodiment of the present invention.

The line valve according to the second embodiment includes a connection pipe 100, and a rotary valve 200, which is rotatably provided in a valve seating part 130 of the connection pipe 100, in the same manner as that of the prior embodiment. Open-and-close restraining guide recesses 141 and inclined assembly guide surfaces 142 are respectively formed in the circumferential inner surface and the circumferential outer surface of the upper end of the valve seating part 130 of the connection pipe 100, such that they are symmetrical with each other. A stop protrusion 222 is provided in a boss 220 of the rotary valve 200. The stop protrusion 222 is guided by the respective open-and-close restraining guide recesses 141, so that the angle at which the rotary valve 200 can be rotated is limited to a predetermined angle (for example, less than an angle of 90°).

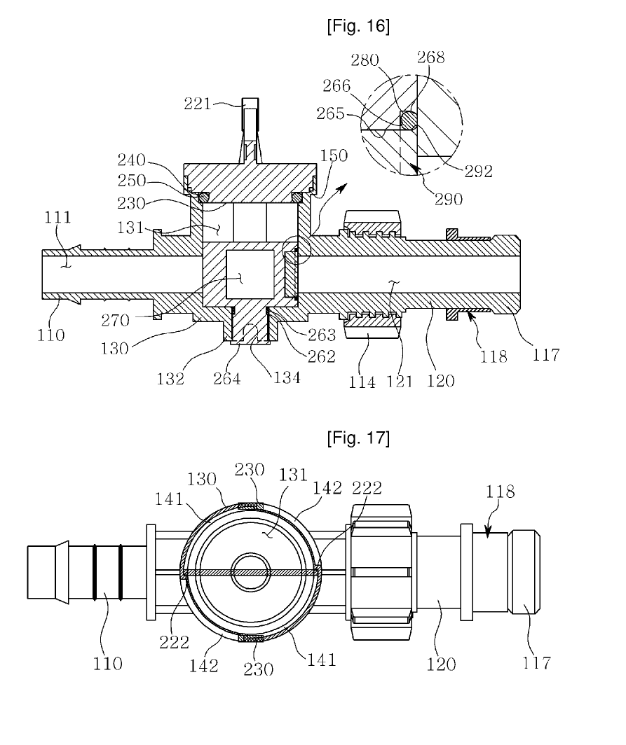

The relationship between the open-and-close restraining guide recesses 141 and the stop protrusion 222 is clearly illustrated in FIGS. 16 through 18 and FIGS. 19 through 22, which show the control positions of the stop protrusion 222 depending on the rotation of the rotary valve 200.

In detail, depending on the rotation of the rotary valve 200, flow passages 111 and 121 of hose connectors 110 and 120 are opened (FIGS. 19 through 22) or closed (FIGS. 16 through 18).

As shown in FIGS. 16 through 18, when the stop protrusion 222 is oriented in the open-and-close restraining guide recesses 141 in a direction parallel to the central axis of the hose connectors 110 and 120, the flow passages 111 and 121 are closed. That is, the area surrounding one of the flow passages 111 and 121 is sealed by an O-ring 280 of the rotary valve 200, thus closing the flow passages 111 and 121.

As shown in FIGS. 19 through 22, when the stop protrusion 222 is oriented in the open-and-close restraining guide recesses 141 in a direction perpendicular to the central axis of the hose connectors 110 and 120, the flow passages 111 and 121 are opened.

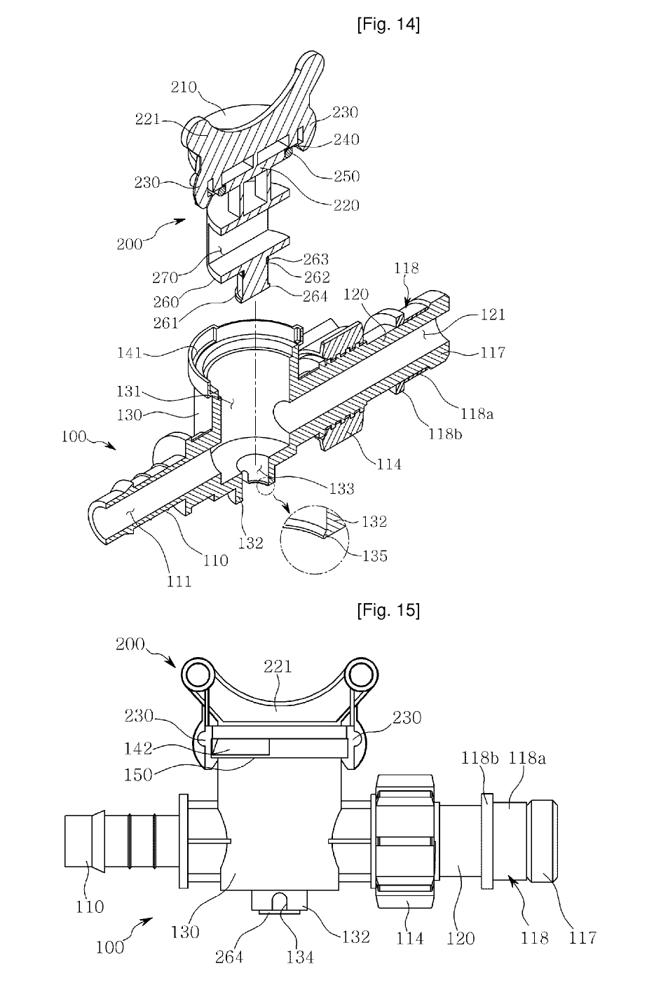

Meanwhile, as shown in FIG. 14, the valve seating part 130 includes a support shaft pipe 132, which has a shaft hole 133 and protrudes downwards from the valve seating part 130 below a receiving space 131. The rotary valve 200 includes a support shaft 261, which protrudes downwards from the lower end of the cylindrical rotating body 260. The support shaft 261 is inserted through the shaft hole 133 of the support shaft pipe 132.

Here, the support shaft pipe 132 has at least one coupling slit 134 to make it possible for the support shaft pipe 132 to be slightly increased in diameter when the support shaft 261 is forcibly fitted thereinto. Furthermore, a support protrusion 135 radially protrudes inwards from the circumferential inner surface of the lower end of the support shaft pipe 132. In addition, an O-ring seat 262 is formed in the support shaft 261 at the junction between the support shaft 261 and the cylindrical rotating body 260, and an O-ring 263 is seated into the O-ring seat 262. A ring-shaped locking protrusion 264, the outer diameter of which is greater than the diameter of the shaft hole 133, is integrally formed on the lower end of the support shaft 261.

To assemble the rotary valve 200 to the connection pipe 100, the cylindrical rotating body 260 of the rotary valve 200 and the boss 220 of the cover plate 210 are press-fitted into the receiving space 131 of the valve seating part 130.

At this time, hooks 230 of the cover plate 210 are moved downwards along the inclined assembly surfaces 142 of the valve seating part 130, and then the lower ends of the hooks 230 are locked to a ring-shaped locking step 150. Simultaneously, the support shaft 261, which is provided under the cylindrical rotating body 260, is inserted through the shaft hole 133 of the support shaft pipe 132, and the ring-shaped locking protrusion 264 of the support shaft 261 is locked to the lower end of the support shaft pipe 132. As such, the rotary valve 200 is rotatably assembled to the connection pipe 100 into a double coupling structure.

Furthermore, in the line valve assembled through the above process, the O-ring 263, which is seated in the O-ring seat 262 of the support shaft 261, seals the shaft hole 133 of the support shaft pipe 132. As well, because the rotation of the support shaft 261, depending on the rotation of the rotary valve 200, is supported by the support protrusion 135 of the support shaft pipe 132, minimal rotational friction is generated.

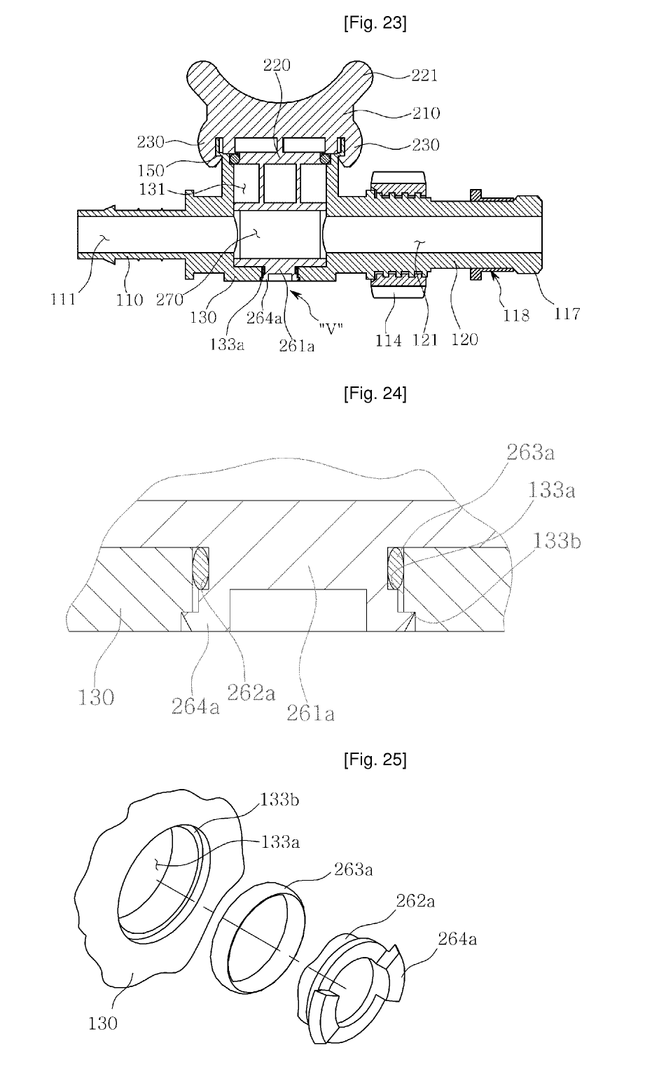

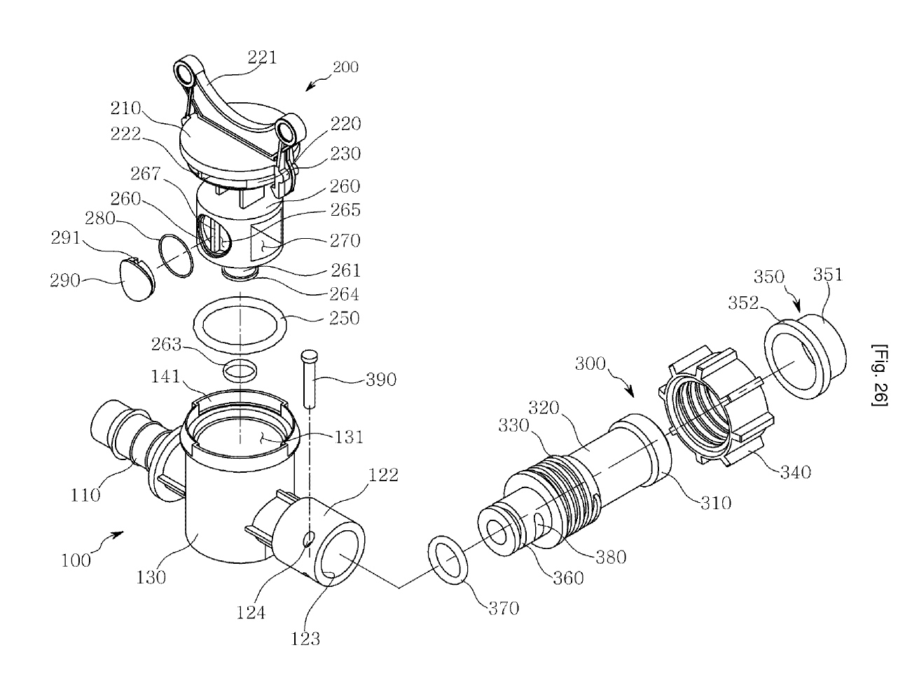

FIGS. 23 through 25 illustrate a modification of the coupling structure between the connection pipe 100 and the rotary valve 200. In this modification, a stepped shaft hole 133a is formed through the lower end of the valve seating part below the receiving space 131. The rotary valve 200 has a support shaft 261a, which protrudes downwards from the lower end of the cylindrical rotating body 260. The support shaft 261a is inserted through the shaft hole 133a.

Furthermore, a stepped part 133b is provided in the lower end of the stepped shaft hole 133a. A pair of locking pieces 264a, each of which has an inclined surface, radially protrudes outwards from the circumferential outer surface of the lower end of the support shaft 261a.

Thus, when the support shaft 261a is inserted into the stepped shaft hole 133a, the locking pieces 264a are slightly reduced in distance therebetween, and are then locked to the stepped part 133b. As a result, the rotary valve 200 is rotatably and reliably coupled to the connection pipe 100 in a double coupling manner.

In the same manner, an O-ring seat 262a is formed in the support shaft 261a at the junction between the support shaft 261a and the cylindrical rotating body 260. An O-ring 263a is seated into the O-ring seat 262a. The O-ring 263a seals the shaft hole 133a.

The general construction of the valve other than the above-mentioned structure remains the same as the prior embodiment, therefore further explanation is deemed unnecessary.

Meanwhile, in the present invention, as shown in FIGS. 26, 27, 30 and 31, the hose connector may have a removable structure, such that one of various kinds of hose connectors can be selected. In this case, the range of use of the valve can be increased. In other words, in the present invention, a hard hose connector 300 for branching of the hard hose or a soft hose connector 400 for connection with the soft hose may be selectively used.

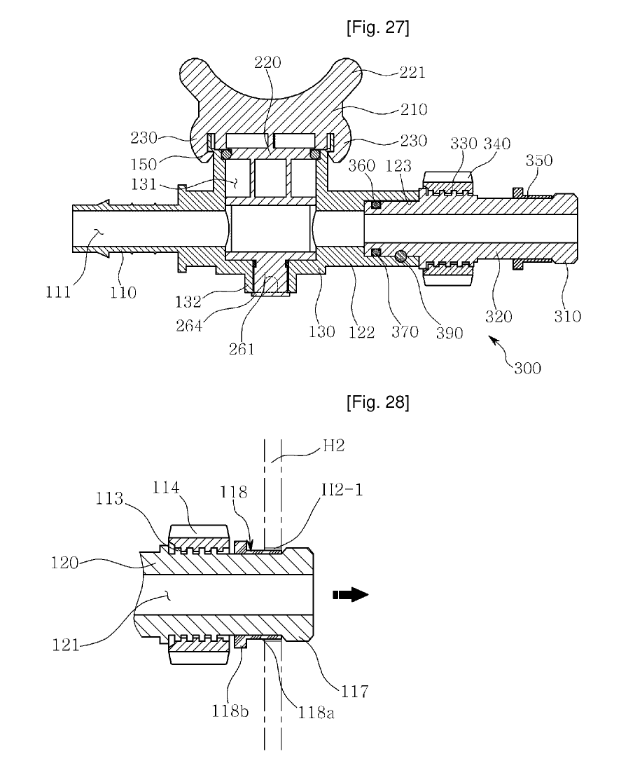

As shown in FIGS. 26 and 27, the removable type hard hose connector 300 includes a pipe body 320, a first end of which is removably connected to the valve seating part 130 of the connection pipe 100, a tightening nut 340, which is threaded onto the circumferential outer surface of the pipe body 320, and an insert part 310, which is provided on a second end of the pipe body 320.

The pipe body 320 has therein a flow passage. An O-ring seat 360 and a locking groove 380 are formed in the first end of the pipe body 320. Furthermore, a threaded part 330 is formed in the circumferential outer surface of the pipe body 320. The tightening nut 340 engages with the threaded part 330 so as to conduct a screw movement. An O-ring 370 is seated into the O-ring seat 360 of the pipe body 320. The outer surface of the first end of the pipe body 320 is sealed by the O-ring 370.

Furthermore, an extension pipe 122 protrudes from the circumferential outer surface of the valve seating part 130 at a predetermined position. A coupling hole 123 is formed through the extension pipe 122. A pin hole 124 is formed through the sidewall of the extension pipe 122. Thus, after the first end of the pipe body 320 is inserted into the coupling hole 123 of the valve seating part 130, a locking pin 390 is inserted into the locking groove 380 through the pin hole 124. Thereby, the pipe body 320 is removably coupled to the valve seating part 130.

The insert part 310, which has an outer diameter greater than that of the pipe body 320, is provided on the second end of the pipe body 320. A packing 350 is disposed between the insert part 310 and the tightening nut 340. The packing 350 integrally includes a close contact ring part 351 and a flange part 352.

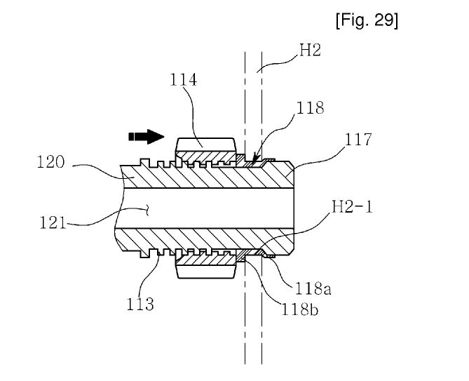

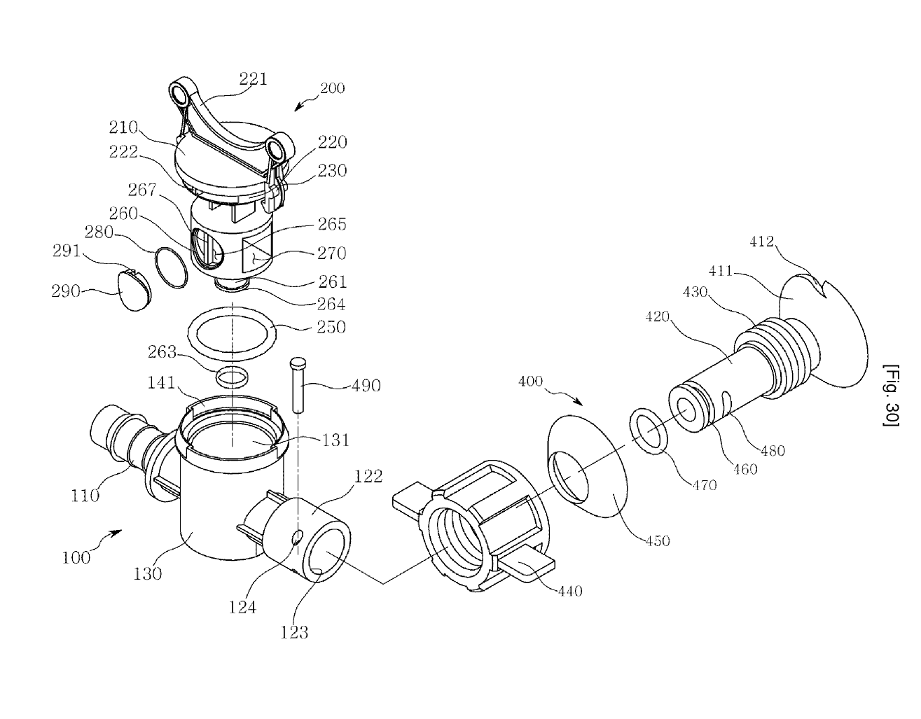

A process of connecting the second end of the pipe body 320 to the hard hose H2 using the corresponding components, including the insert part 310 and the packing 350, is illustrated in FIGS. 28 and 29. This process is the same as that of the prior embodiment, therefore further explanation will be skipped.

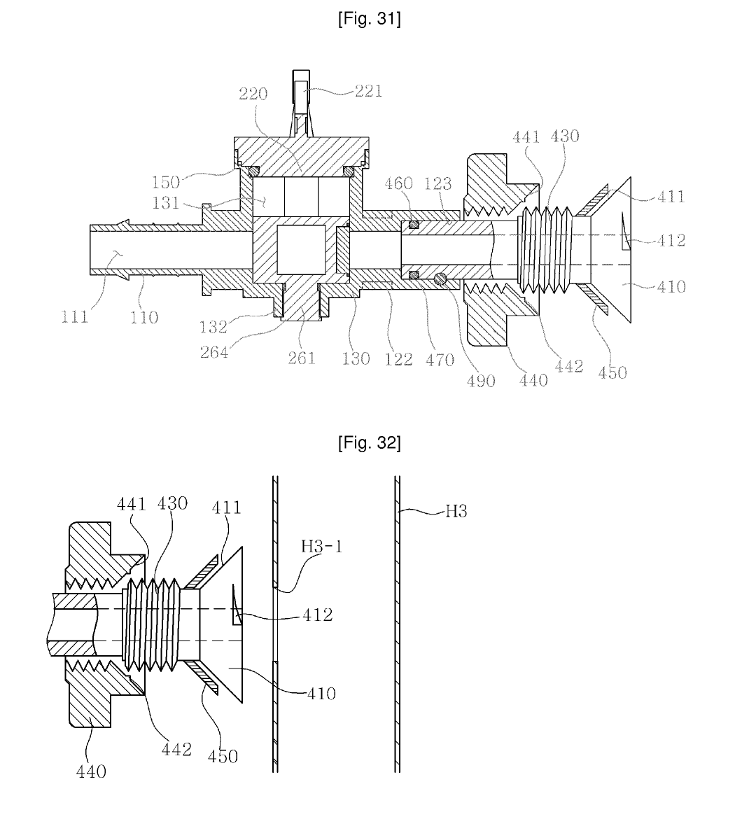

Meanwhile, as shown in FIGS. 30 and 31, a removable type soft hose connector 400 includes a pipe body 420, a first end of which is removably connected to the valve seating part 130, a tightening nut 440, which is threaded onto the circumferential outer surface of the pipe body 420, and an insert part 410, which is provided on a second end of the pipe body 420.

The pipe body 420 has therein a flow passage. An O-ring seat 460 and a locking groove 480 are formed in the first end of the pipe body 420. Furthermore, a threaded part 430 is formed in the circumferential outer surface of the pipe body 420. The tightening nut 440 engages with the threaded part 430 so as to conduct a screw movement. An O-ring 470 is seated into the O-ring seat 460 of the pipe body 420. The outer surface of the first end of the pipe body 420 is sealed by the O-ring 470.

Furthermore, an extension pipe 122 protrudes from the circumferential outer surface of the valve seating part 130 at a predetermined position. A coupling hole 123 is formed through the extension pipe 122. A pin hole 124 is formed through the sidewall of the extension pipe 122. Thus, after the first end of the pipe body 420 is inserted into the coupling hole 123 of the valve seating part 130, a locking pin 490 is inserted into the locking groove 480 through the pin hole 124. Thereby, the pipe body 420 is removably coupled to the valve seating part 130.

The insert part 410, which is provided in the second end of the pipe body 420, has a tapered outer surface 441. Furthermore, an insert guide slot 412 is formed in the tapered outer surface 441.

In addition, a tapered inner surface 441 is formed in the circumferential inner surface of an end of the tightening nut 440, which is adjacent to the insert part 410 of the pipe body 420. A ring-shaped compression protrusion 442 protrudes from the tapered inner surface 441. Thanks to the compression protrusion 442, even if the valve is not provided with a compression packing 450, the inner tapered surface 441 can be brought into watertight contact with the outer tapered surface 411 of the insert part 410 by tightening movement of the tightening nut 440.

Of course, the compression packing 450, having a tapered shape, may be interposed between the inner tapered surface 441 of the tightening nut 440 and the outer tapered surface of the insert part 410.

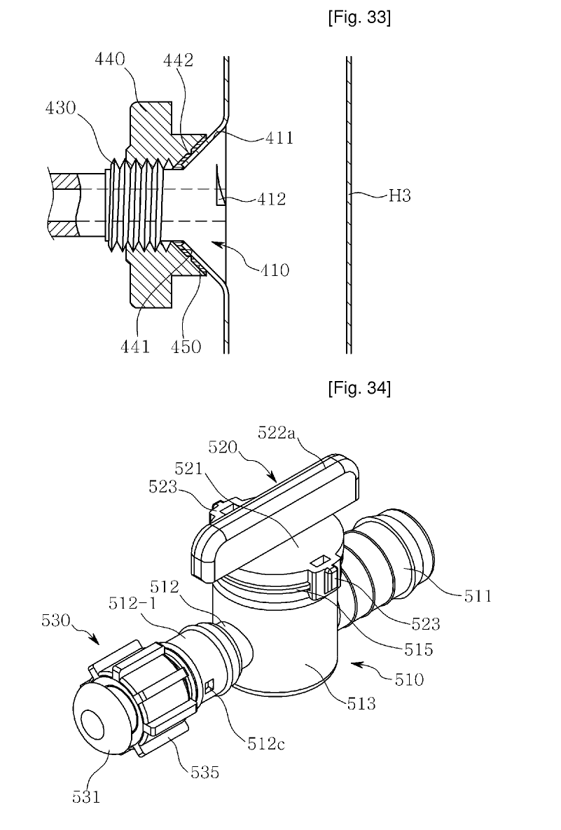

A process of connecting the removable type soft hose connector 400 to the soft hose H3 will be explained in detail with reference to FIGS. 32 and 33.

After the insert guide slot 412, formed in the insert part 410 of the pipe body 420, is disposed adjacent to the hole H3-1 of the soft hose H3, the pipe body 420 is rotated. Then, the insert part 410 is inserted into the soft hose H3. Thereafter, the tightening nut 440 is moved forwards by the screw movement. Then, the outer tapered surface 411 of the insert part 410 and the inner tapered surface 441 of the tightening nut 440 strongly compress the area surrounding the hole H3-1. Furthermore, the compression protrusion 442 of the inner tapered surface 441 compresses the area of the soft hose H3 surrounding the hole, thus more reliably sealing the hole. Even though water is supplied into the soft hose H3, so that the soft hose H3 is increased in diameter, the sealed state can be reliably maintained.

Of course, if the compression packing 450 is interposed between the tightening nut 440 and the insert part 410, the area surrounding the hole H3-1 of the soft hose H3 can be more reliably sealed by compression of the tightening nut 440.

In this embodiment, a connecting hose H1, which is coupled to a water spraying means such as a sprinkler, is connected to the hose connector 110, which is provided in one end of the valve, and, thereafter, the removable type hard hose connector 300 or the removable type soft hose connector 400, which is provided in the other end of the valve, is connected to the hard hose H2 or the soft hose H3, which is the main water supply pipe, thus controlling the supply of water.

As well as when connecting the removable type hard hose connector 300 to the hard hose, when connecting the removable type soft hose connector 400 to the soft hose H3, the pipe body 420 may be connected to the extension pipe 122 of the connection pipe 100 after the removable type soft hose connector 400 has been first coupled to the soft hose H3. Alternatively, the removable type soft hose connector 400 may be coupled to the soft hose H3 after it has been connected to the extension pipe 122.

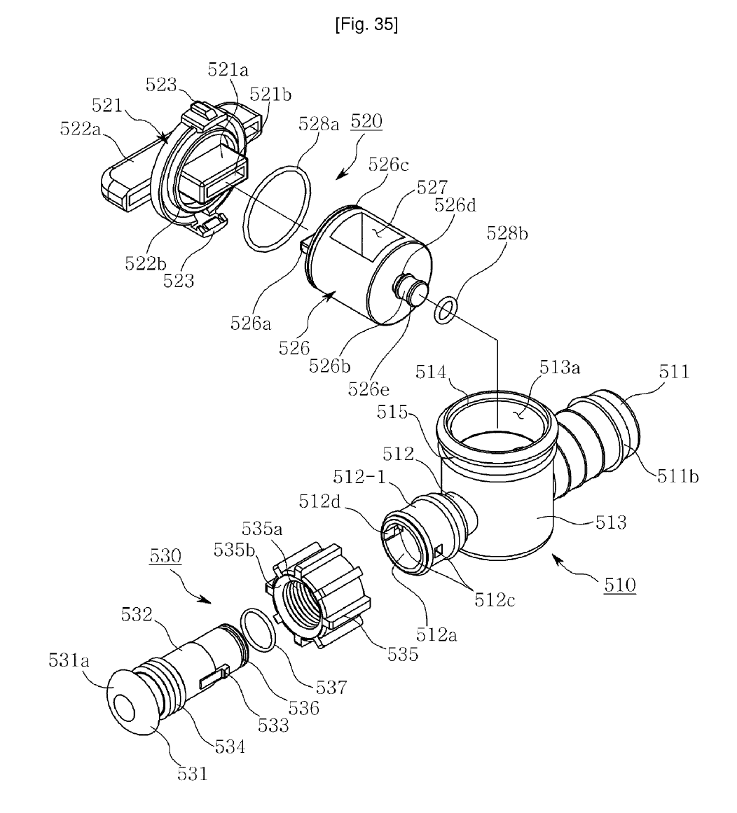

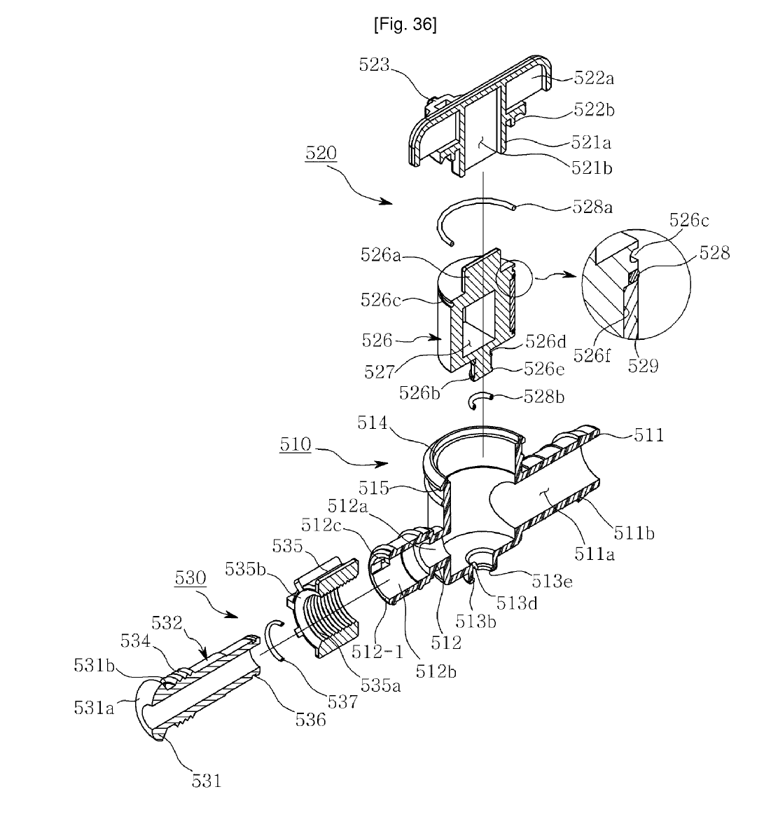

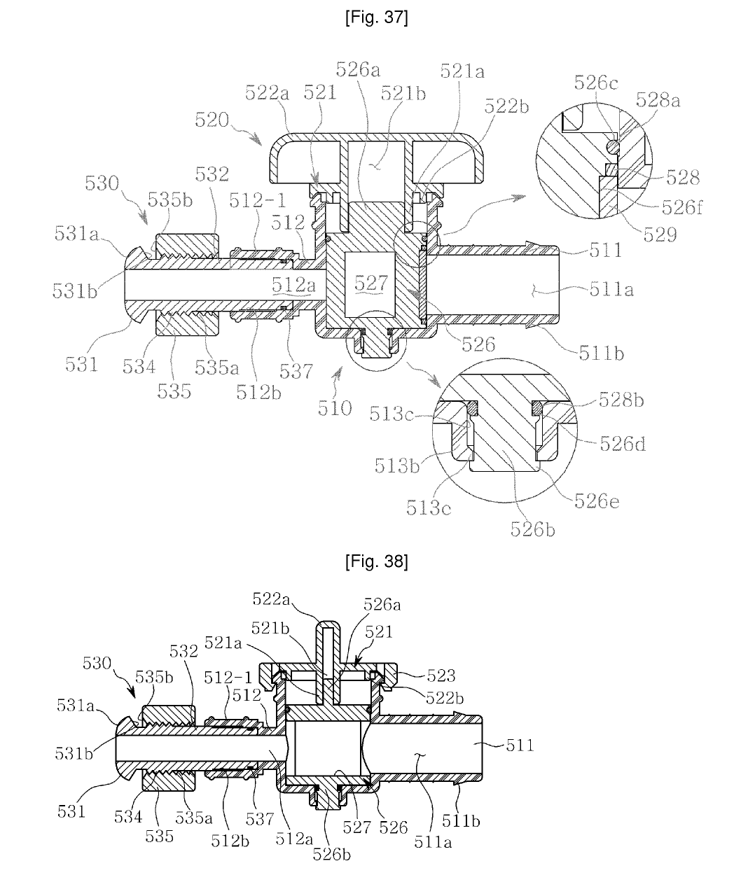

FIGS. 34 through 39 illustrate a third embodiment of the present invention. As shown in the drawings, a line valve according to the third embodiment includes a connection pipe 510 and a rotary valve 520, which is rotatably provided in the connection pipe 510, in the same manner as that of the first and second embodiments.

Furthermore, the connection pipe 510 has a valve seating part 513 in a medial portion thereof. The valve seating part 513 defines therein a receiving space 513a, into which the rotary valve 520 is rotatably received.

The connection pipe 510 includes at least two hose connectors 511 and 512. The hose connectors 511 and 512 have respective flow passages 511a and 512a therein. The flow passages 511a and 512a communicate with the receiving space 513a.

In addition, a ring-shaped depression 514 and a ring-shaped locking step 515 are respectively formed in the circumferential inner surface and the circumferential outer surface of the upper end of the valve seating part 530.

The rotary valve 520 includes a cover plate 521 and a cylindrical rotating body 526, which are separably assembled with each other.

The cover plate 521 has a handle 522a on the upper surface thereof. At least two hooks 523 are provided on the circumferential outer edge of the cover plate 521. Furthermore, a ring-shaped protrusion 522b, which is inserted into the ring-shaped depression 514 of the valve seating part 513, and an assembly part 521a, which is disposed at the center of the ring-shaped protrusion 522b, are provided under the lower surface of the cover plate 521. An assembly slot 521b is formed in the assembly part 521a.

The cylindrical rotating body 526 has a passage hole 527, through which the flow passages 511a and 512a of the hose connectors 511 and 512 communicate with each other. An O-ring 528, which seals one of the flow passages 511a and 512a, is provided in the cylindrical rotating body 526 at a position perpendicular to the passage hole 527. The cylindrical rotating body 526 has an assembly protrusion 526a on the upper surface thereof. The assembly protrusion 526a is fitted into the assembly slot 521b of the cover plate 521.

As well, an O-ring seat 5267c is formed in the circumferential outer surface of the upper end of the cylindrical rotating body 526. The O-ring 528a is seated into the O-ring seat 526c.

Thanks to the structure in which the cover plate 521 and the cylindrical rotating body 526 are separably assembled with each other, the cover plate 521 can be formed such that the handle 522a is sufficiently thick. Therefore, the present invention can avoid various problems caused in a forming process using a mold. Furthermore, because the handle 522a can have an appropriate thickness, it is prevented from being broken in the winter or similar circumstances.

The valve seating part 513 includes a support shaft pipe 513b, which protrudes downwards from the valve seating part 513 below a receiving space 513. The support shaft pipe 513b has a shaft hole 513c therein. Corresponding with the support shaft pipe 513b, a support shaft 525b protrudes downwards from the lower end of the cylindrical rotating body 526. At least two coupling slits 513d are formed in the end of the support shaft pipe 513b at diametrically opposite positions. Thus, thanks to the coupling slits 513d, when the support shaft 525b is press-fitted into the support shaft pipe 513b, the end of the support shaft pipe 513b is elastically increased in diameter and returned to its original state.

A frictional protrusion 513e radially protrudes inwards from the circumferential inner surface of the end of the support shaft pipe 513b. An O-ring seat 526d is formed in the support shaft 525b at a position adjacent to the cylindrical rotating body 526. An O-ring 528b is seated into the O-ring seat 526d. A ring-shaped locking protrusion 526e, which has a stepped flange shape, and the outer diameter of which is greater than the diameter of the shaft hole 513c of the support shaft pipe 513b, is integrally formed on the lower end of the support shaft 525b.

A process of assembling the rotary valve 520 with the connection pipe 510 will be explained herein below.

First, the assembly protrusion 526a of the cylindrical rotating body 526 is inserted into the assembly slot 521b of the cover plate 521. Thereafter, the cylindrical rotating body 526 is press-fitted into the receiving space 513a of the valve seating part 513.

Then, the hooks 523 of the cover plate 521 are locked to the locking step 515 of the valve seating part 513. Simultaneously, the support shaft 525b of the cylindrical rotating body 526 is inserted into the shaft hole 513c of the support shaft pipe 513b, and the ring-shaped locking protrusion 526e is locked to the lower end of the support shaft pipe 513b.

As a result, the cover plate 521 and the cylindrical rotating body 526 of the rotary valve 520 are assembled with the valve seating part 513 of the connection pipe 510 to form a double coupling structure, thus increasing the reliability of the assembled structure.

Furthermore, the upper end of the receiving space 513a of the valve seating part 513 is sealed by the O-ring 528a of the cylindrical rotating body 526, and the lower end thereof is sealed by the O-ring 528b of the support shaft 525b.

In this state, the cover plate 521 and the cylindrical rotating body 526 integrally conduct rotating motion. Depending on the rotation of the cover plate 521 and the cylindrical rotating body 526, the flow passages 511a and 512a of the connection pipe 510 communicate with each other through the passage hole 527 or are isolated from each other.

Here, because part of the circumferential outer surface of the support shaft 252b is rotatably supported by the frictional protrusion 513b of the support shaft pipe 513b, frictional force attributable to rotation is minimized.

Meanwhile, the O-ring 528 is provided in the cylindrical rotating body 526 at a position perpendicular to the passage hole 527, so that one of the flow passages 511a and 512a of the connection pipe 510 can be sealed by the O-ring 528.

The cylindrical rotating body 526 has a coupling depression 526f in the outer surface thereof at a position perpendicular to the passage hole 527. The O-ring 528 is seated in the edge of the coupling depression 526f. Thereafter, a fastening member 529 is fitted into the coupling depression 526f, thus preventing the O-ring 528 from being undesirably removed.

Furthermore, of the hose connectors 511 and 512, the hose connector 511 that is disposed at the first end of the connection pipe may have a removal prevention protrusion 511b on the circumferential outer surface thereof, so that a hose coupled to the connector is prevented from being undesirably removed. Furthermore, the other hose connector 512, which is disposed at the second end of the connection pipe, may be removably connected to a removable type hose connector 530 such that it can be directly coupled to the main water supply pipe.

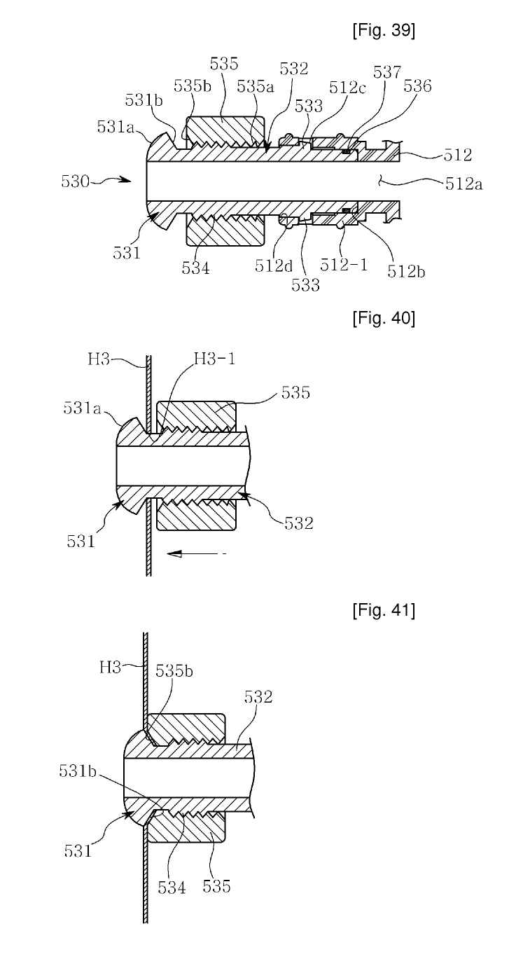

As shown in FIG. 39, the removable type hose connector 530 includes a pipe body 320, a first end of which is removably connected to the hose connector 512 that is disposed at the second end of the connection pipe 510, a tightening nut 535, which is threaded onto the circumferential outer surface of the pipe body 532, and an insert part 531, which is provided on a second end of the pipe body 532.

Furthermore, an extension pipe 512-1 steppedly extends from the hose connector 512 coupled to the valve seating part 513. A coupling seat 512b is defined in the extension pipe 512-1, and a key hole 512c is formed through the sidewall of the extension pipe 512-1.

The pipe body 532 of the removable type hose connector 530 has an O-ring seat 536 at a first end thereof, and an O-ring 537 is seated into the O-ring seat 536. The O-ring 537 seals the contact surfaces between the pipe body 532 and the extension pipe 512-1. A coupling protrusion 512c, which is locked to the key hole 512c of the extension pipe 512-1, is provided on the pipe body 531 behind the O-ring 537.

Furthermore, a threaded part 534 is formed on the circumferential outer surface of the pipe body 532. The tightening nut 535 is threaded onto the threaded part 534. The tightening nut 535 has a threaded part 535a, which engages with the threaded part 534 of the pipe body 532. A tapered surface 535b is formed in the end of the threaded part 535a adjacent to the insert part 531.

As shown in FIGS. 40 and 41, the insert part 531, which is provided on the second end of the pipe body 532, has a rounded surface 531a such that it can be easily inserted into a hole H3-1 of a hose H3. A tapered surface 531b is formed on the rear surface of the insert part 531, which is opposite the rounded surface 531a. The tapered surface 531b of the insert part 531 is inclined at the same angle as the tapered surface 535b of the tightening nut 535.

In the valve having the above-mentioned construction, the user inserts the insert part 531 of the removable type hose connector 530 into the hole H3-1 of the hose H3 (see, FIG. 40). Thereafter, the user rotates the tightening nut 535 and thus moves it forwards through the screw movement. Then, the tapered surface 531b of the insert part 531 and the tapered surface 535b of the tightening nut 535 tightly compress the area surrounding the hole H3-1 of the hose H3. Thereby, the area surrounding the hole H3-1 of the hose H3 is reliably sealed (see, FIG. 41).

Subsequently, the first end of the pipe body 532 is inserted into the extension pipe 512-1 of the hose connector 512 until the coupling protrusion 533 of the pipe body 532 is locked to the key hole 512d of the extension pipe 512-1. Of course, after the first end of the pipe body 532 is first coupled to the extension pipe 512-1, the insert part 531 of the removable type hose connector 530 may be connected to the hose H3.

Furthermore, the tapered surface 53 lb of the insert part and the tapered surface 535b of the tightening nut 535 may have a curved structure.

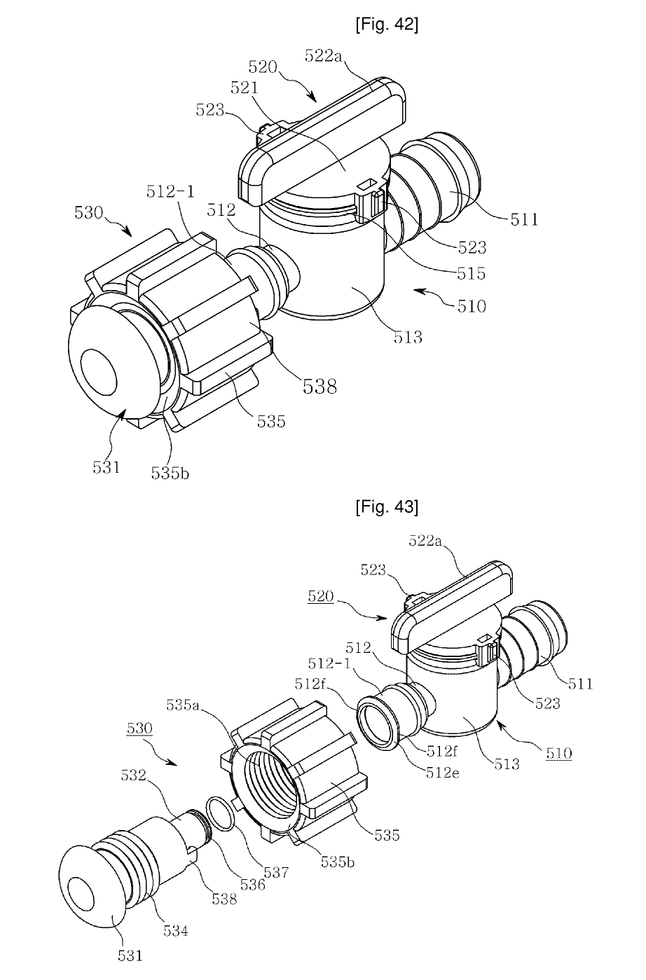

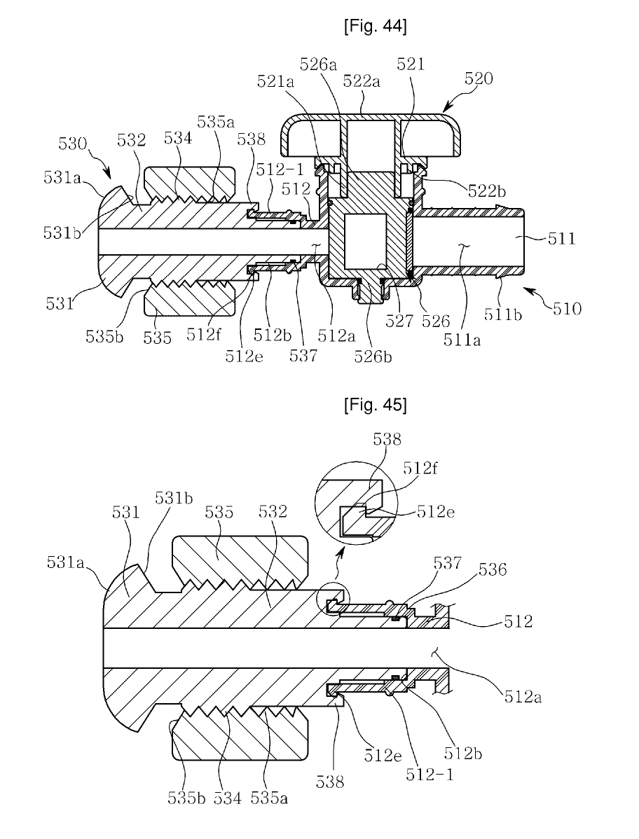

Meanwhile, FIGS. 42 through 45 illustrate a modification of the removable type hose connector 530 according to the third embodiment of the present invention. A flange 512e is provided on an end of the extension pipe 512-1. Two key notches 512f are formed in the flange 512e at positions facing each other. To correspond thereto, hooks 538 are provided on an end of the pipe body 532. After the hooks 538 are inserted into the key notches 512f, the pipe body 532 is rotated. Then, the hooks 538 are locked to the flange 512e.

1. A line valve, comprising:
a connection pipe including at least two hose connectors oriented in directions different from each other, each of the hose connectors having a flow passage therein; and
a rotary valve rotatably provided in the connection pipe, such that communication between the flow passages is selectively controlled depending on axial rotation of the rotary valve, wherein
the rotary valve comprises a cover plate exposed outside the connection pipe, and a cylindrical rotating body rotatably provided in the connection pipe, and
the cylindrical rotating body has a passage hole therein, and an O-ring is provided in a circumferential outer surface of the cylindrical rotating body at a position perpendicular to the passage hole, the O-ring being fastened to the cylindrical rotating body by a fastening member.

2. The line valve according to claim 1, wherein a coupling recess is formed in the circumferential outer surface of the cylindrical rotating body at the position perpendicular to the passage hole, a ring-shaped stepped part is formed in an outer edge of the coupling recess, and a ring-shaped rounded part is formed in an outer edge of the ring-shaped stepped part, wherein
the fastening member has an outer diameter less than an inner diameter of the ring-shaped stepped part, and a rounded part is formed in an outer edge of the fastening member, and
the O-ring is seated into the ring-shaped stepped part, the O-ring being partially surrounded both by the rounded part of the ring-shaped stepped part and by the rounded part of the fastening member, so that part of the O-ring is exposed outside the rounded parts.

3. The line valve according to claim 2, wherein the fastening member has a curvature radius equal to a curvature radius of the cylindrical rotating body.

4. The line valve according to claim 1, wherein one hose connector selected from the two or more hose connectors comprises: a plurality of removal prevention protrusions formed on a circumferential outer surface of the hose connector, each of the removal prevention protrusions having a right-angled triangular cross-section, one surface of which is inclined in one direction, wherein the inclined surface of the removal prevention protrusion faces a direction in which a hose is connected to the hose connector.

5. The line valve according to claim 1, wherein one hose connector selected from the two or more hose connectors comprises: an insert part provided on an end of the hose connector, the insert part being increased in diameter to a distal end thereof; and a ring-shaped packing fitted over a circumferential outer surface of the insert part so that the ring-shaped packing is brought into close contact with an area around a hole formed in a hard hose by an external force, the ring-shaped packing being radially extended outwards when the ring-shaped packing is compressed towards the insert part.

6. The line valve according to claim 5, wherein the hose connector further comprises: a tightening nut threaded onto the circumferential outer surface of the hose connector, so that the ring-shaped packing is compressed towards the insert part by the tightening nut.

7. The line valve according to claim 1, wherein the cover plate of the rotary valve is rotatably coupled to the connection pipe.

8. The line valve according to claim 1, wherein the cylindrical rotating body of the rotary valve comprises a support shaft protruding from a lower end of the cylindrical rotating body, and the connection pipe has in a bottom thereof a support shaft pipe rotatably supporting the support shaft.

9. The line valve according to claim 8, wherein an O-ring is provided on a circumferential outer surface of the support shaft, and the support shaft is rotatably coupled at a lower end thereof to a lower end of the support shaft pipe.

10. The line valve according to claim 9, wherein at least one support protrusion radially protrudes inwards from a circumferential inner surface of the support shaft pipe.

11. The line valve according to claim 1, wherein the connection valve comprises a valve seating part, to which the rotary valve is coupled, the valve seating part having therein a receiving space in which the rotary valve is rotatably received.

12. The line valve according to claim 11, wherein the valve seating part has an open-and-close restraining guide recess in an upper end thereof, and the rotary valve has a stop protrusion to be guided along the open-and-close restraining guide recess, so that an angle by which the rotary valve is rotated is limited within a predetermined range.

13. The line valve according to claim 1, wherein the cover plate and the cylindrical rotating body are separably assembled with each other.

14. The line valve according to claim 13, wherein an O-ring is provided on a lower end of the cover plate to ensure watertightness between the cover plate and the cover plate.

15. The line valve according to claim 1, wherein each of the two or more hose connectors comprises a removable type hose connector separably coupled to the connection pipe.

16. The line valve according to claim 15, wherein the removable type hose connector comprises:
a pipe body removably and watertightly coupled at a first end thereof to the connection pipe;
an insert part provided on a second end of the pipe body and having a tapered surface; and
a tightening nut threaded onto a circumferential outer surface of the pipe body.

17. The line valve according to claim 16, wherein a compression packing is interposed between the insert part and the tightening nut.

18. The line valve according to claim 16, wherein the tightening nut has a tapered surface on a circumferential inner surface of an end thereof adjacent to the insert part corresponding to the tapered surface of the insert part.

19. The line valve according to claim 18, wherein each of the tapered surfaces is curved at a predetermined curvature radius.

20. The line valve according to claim 16, wherein the pipe body has at least one hook on the first end thereof, and the connection pipe has at least one key notch corresponding to the hook.
